(19) United States
(12) Patent Application Publication
(10) Pub. No.: US 2014/0165284 A1
(43) Pub. Date: Jun. 19, 2014

(54) Unknown

(71) Applicant: SOCIETE DYNAMIKA, Perigueux (FR)

(72) Inventor: Didier ROUX, Perigueux (FR)

(73) Assignee: SOCIETE DYNAMIKA, Perigueux (FR)

(21) Appl. No.: 13/952,750

(22) Filed: Jul. 29, 2013

(30) Foreign Application Priority Data
Dec. 13, 2012 (FR) 1262011

(51) Int. Cl. A61H 33/00

(52) U.S. Cl. CPC A61H 33/60
USPC 4/584

(57) ABSTRACT

A basin includes a basin body that can house a device for athletic activities for executing physical exercises in an aquatic environment. The device for athletic activities includes a frame that can be removably housed in the basin body. With the basin body including at least two opposite walls, at least one of the opposite walls defines a wall extension forming a projection into the basin body, with the free end of the wall extension including a device for receiving/holding one end of the frame. The frame includes a cassette that can move in translation along an axis of displacement and a drive system for moving the cassette along the axis of displacement. The cassette includes a body, with the cassette body being provided with at least one hole that laterally passes through the cassette body for accommodating a pedal system making it possible to perform physical exercises.

### BACKGROUND OF THE INVENTION

1. Field of the Invention

This invention relates to a bath or spa for performing physical exercises in an aquatic environment.

2. State of the Art

It is well known that the athletic and gymnastic activities in the water are sources of considerable well-being for the user while allowing the latter to accomplish both a muscular and a cardiological workout.

It is also known that performing physical activities in the water is beneficial for rehabilitation and weight loss.

Thus, drive/seat units designed to be installed in compartments supplied with water for performing physical activities in an aquatic environment are known. The drive system and the seat are typically attached to a support that is integral with the bottom, or floor, of the compartment.

Consequently, they cannot be removed to allow a normal bath to be taken.

In addition, they make it no longer possible to replace the drive system by another athletic device making possible a different athletic activity in the water based on the user's wishes or a linking of medically recommended athletic activities.

Finally, it is noted that the structural elements that constitute the conventional drive system are fixed once mounted on their support that is integral with the floor of the compartment. They therefore do not make it possible to adjust the positioning of the pedals to take into account the user's size.

However, it is imperative that the user can perform physical activities in a comfortable position, adapted to his morphology so as to obtain sufficient muscular relaxation while performing a veritable active draining on the body.

There is a pressing need for a support/seat unit that makes it possible to overcome the drawbacks disclosed above.

The objective of this invention is therefore to propose a multi-functional support/seat unit, simple in its design and in its operating mode, inexpensive, making possible an adjustment of the positioning of the support elements of the feet for taking into account the size of the user.

Such a multi-functional unit is therefore able to accommodate various athletic devices for performing individual physical activities in an aquatic environment with one and the same support/seat unit.

Another object of this invention is a compartment, or bath, that is equipped with such a multi-functional support/seat unit, making it possible for the user to be able to perform a physical activity in a comfortable position.

### BRIEF DESCRIPTION OF THE INVENTION

For this purpose, the invention relates to a basin that comprises a basin body that delimits an inside volume that can house a device for athletic activities for executing physical exercises in an aquatic environment, with said device for athletic activities comprising a frame that can be housed in a removable manner in said basin body.

According to the invention,
Said basin body comprising at least two opposite walls, at least one of said opposite walls defines a wall extension forming a projection into the inside volume delimited by the basin body, with the free end of said wall extension comprising a means of receiving/holding one end of said frame,
Said frame comprising a cassette that can move in translation along an axis of displacement and a drive system for moving said cassette along said axis of displacement,
Said cassette comprising a body, said cassette body being provided with at least one hole that laterally passes through said cassette body for accommodating a pedal system making it possible to perform physical exercises.

This free end of the wall extension is advantageously a surface placed facing the opposite wall of the basin body.

This basin is advantageously equipped with a drain by an outlet placed at the bottom of the basin.

In different particular embodiments of this basin, each having its particular advantages and capable of numerous possible technical combinations:
Said opposite walls define two wall extensions forming a projection into the inside volume delimited by the basin body by being placed facing one another, with said wall extensions thus defining a housing for receiving said frame, the surfaces facing said extensions each comprising a means of receiving/holding one end of said frame,
Said means of receiving/holding one end of said frame comprises at least one guide rail portion integral with said end or surface of said wall extension,
Said drive system for moving said cassette along said axis of displacement comprises a vertical endless screw defining a vertical axis along which said cassette moves and an element for control of said endless screw.

Advantageously, the control element of said endless screw comprises a crank.
Said pedal system is a drive system or a pedal system infinitely reproducing the movement made when an individual climbs steps, the latter also being known under the name of “stepper,”
Said basin body comprises a seat, with said seat being placed in the upper part of one of said wall extensions,
With the unit formed by said frame and said at least one wall extension defining a longitudinal axis and said basin body comprising a seat, said seat moves in translation along an axis that is parallel to or merged with said longitudinal axis to allow the seat to be adjusted relative to said frame,
Said basin body comprises a crossbar that makes it possible for the user to support himself.

In a more general manner, this basin body comprises a handle that makes it possible for the user to support himself.

Preferably, this handle, which comprises at least one grip, is connected to the basin body while being movable around an axis of rotation for allowing the adjustment of the position of said at least one grip relative to said frame.

Advantageously, the rotation of this handle around the axis of rotation is controlled by a control element that is offset and placed on the basin body. This control element can be an indexer on a toothed wheel.

In an advantageous manner, the drive that is inserted into the bath and the orientation of the handle make it possible for the user to have an ideal position relative to the water jets designed for massage and for performing physical exercises in four positions (seated, lying down, triathlete, and dancer)
With said opposite walls of said basin body being connected to one another by side walls between which said frame is placed, at least one of said side walls comprises nozzles, each designed to emit a water jet.

Advantageously, these nozzles can be oriented to ensure the adjustment of the position of the jet emitted by the corresponding nozzle in the inside volume of the basin body.

Preferably, two of said nozzles are positioned in such a way that the water jets emitted by these two nozzles are sent to two separate points of said inside volume, each corresponding to an end displacement position of the knee of the user during the use of said pedal system.

These points are, for example, top and bottom end displacement positions of the knee during a pedaling cycle.

Likewise, with the basin body comprising a seat, one of these nozzles is positioned on one of said side walls in such a way that the water jet emitted by this nozzle is sent to a point placed above said seat, preferably approximately at the hip of said user.
The positioning of at least some of said nozzles on said side wall defines a triangle,
Said frame comprises a bar forming said axis of displacement, with said bar passing through an opening placed at a first end of said cassette.

Preferably, the other end of the cassette comprises two wings forming extensions of the side walls of this cassette and designed to come on either side of one end of said frame for keeping said cassette in position during the actuation of said pedal system by the user.
Said basin body is made of plastic, composite material, metal material, enameled material or combinations of these elements.

This invention also relates to a bath comprising a water basin as described above.

This invention also relates to a spa comprising a water basin as described above.

This invention also relates to a method for treating the human body for aesthetic, medical or rehabilitation purposes in which at least the legs of the individual are immersed in a liquid that is received in a basin as described above, and water jets are sent over at least the legs and the basin of said individual at massage points of the human body.

Preferably, the position of at least said cassette is adjusted in advance along said axis of displacement in such a way as to adjust the position of the user relative to said jets emitted by said nozzles in such a way that said massage points are touched by said water jets.

Of course, it is also possible in addition or alternately to adjust the seated position of the user in the basin while performing the adjustment of the seat.

### BRIEF DESCRIPTION OF THE DRAWINGS

Other particular advantages, objects and characteristics of this invention will emerge from the following description given, in an explanatory and in no way limiting object, relative to the accompanying drawings, in which:

FIG. 1 shows a partial top view of a bath according to a particular embodiment of this invention;

FIG. 2 diagrammatically shows a perspective view of the frame of the bath of FIG. 1, with the partially shown drive system operating in such a way that the pedal describes a circular path;

FIG. 3 shows the frame of FIG. 2 without the drive system;

FIG. 4 is a partial and enlarged view of the frame of FIG. 2 showing the connection between the crank and the endless screw;

FIG. 5 shows some of the stages leading to the positioning of the frame of FIG. 2 in the receiving housing defined by the wall extensions of the bath body of the bath of FIG. 1: FIG. 5a) showing the stage for inserting this frame into the housing and FIG. 5b) showing the final positioning of the frame in its housing;

FIG. 6 is a view showing a user entering the bath of FIG. 1 by the upper end of the basin body after having climbed several steps of a set of stairs placed outside forming an integral part of said bath;

FIG. 7 is a partial and perspective view of the bath of FIG. 1 showing the arrangement of nozzles on a side wall of this basin body.

### DETAILED DESCRIPTION OF EMBODIMENTS OF THE INVENTION

First of all, it is noted that the figures are not to scale.

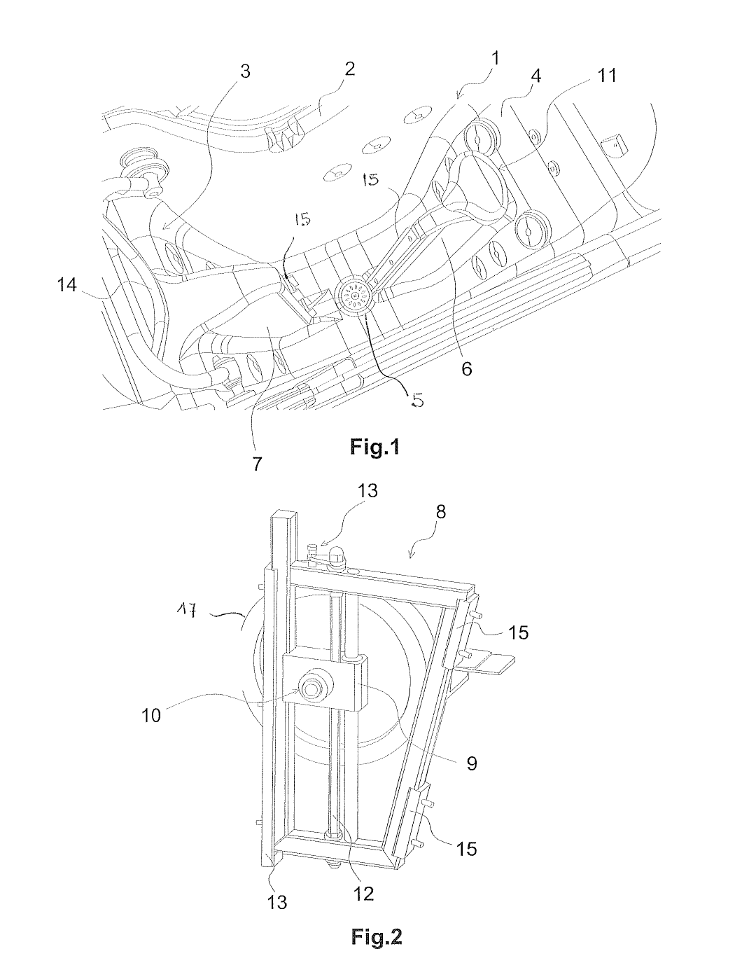

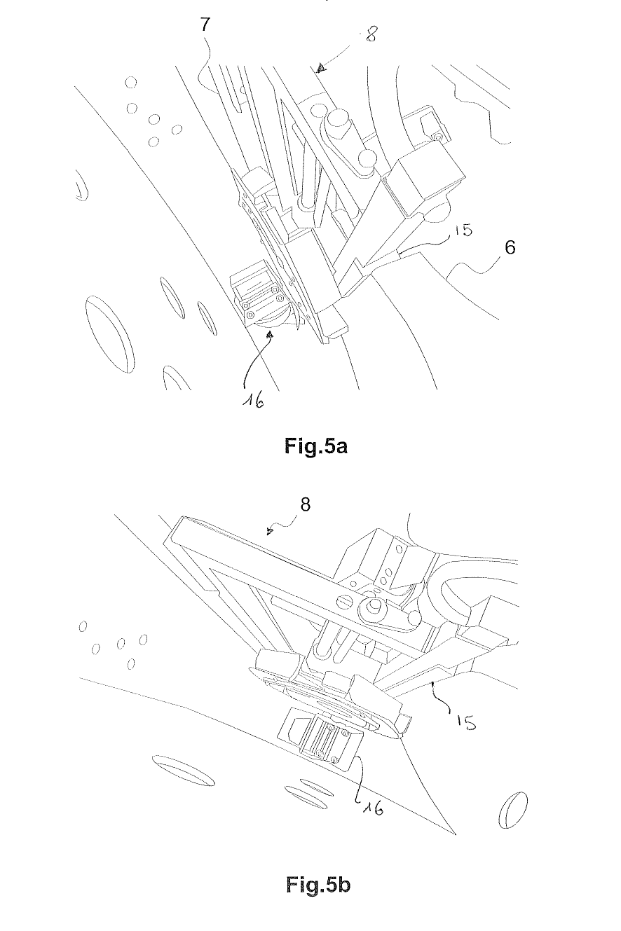

FIGS. 1 to 7 show a bath for performing physical exercises in an aquatic environment according to a preferred embodiment of the invention.

This bath 1 comprises a bath body 2 that is made of plastic material here. This bath body 2 comprises two opposite walls 3, 4 and two side walls defining an inside volume designed to receive the water provided by a hot and cold water supply (not shown).

This bath body 2 also comprises an outlet 5 placed at the bottom of this bath body to ensure the draining of the water that is contained in the bath body 2. An opening placed in the upper part of this bath body makes it possible for the user to enter the bath.

The opposite walls 3, 4 of the bath body define two wall extensions 6, 7 projecting into the basin body by being placed facing one another, with these wall extensions 6, 7 thus defining, with their free surfaces opposite, a housing for receiving the frame 8 of a device for athletic activities.

The surfaces facing these wall extensions 6, 7 each comprise a means 15 of receiving/holding one end of said frame 8, this means of receiving/holding one end of the frame comprising one or more slides attached to the surface of the corresponding wall extension.

This frame 8 is removable for advantageously allowing the operator to take a normal bath.

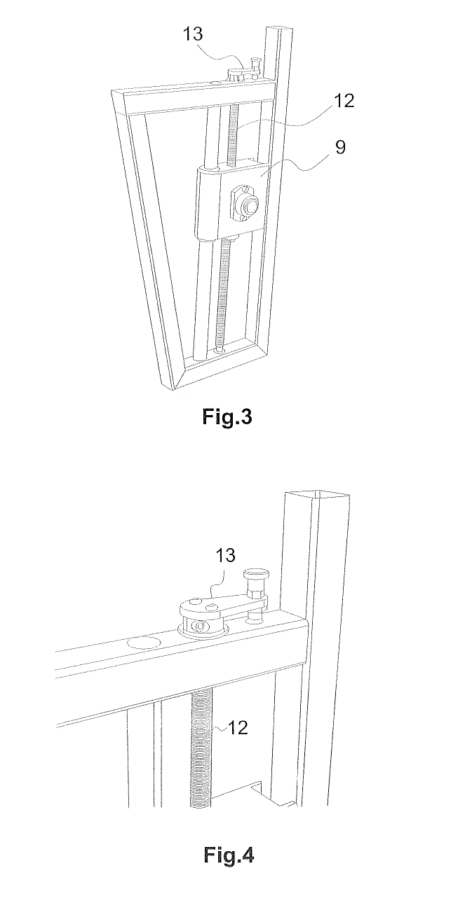

The frame 8 comprises a cassette 9 comprising a cassette body provided with a hole 10 that laterally passes through this body to receive a drive system making it possible to perform physical exercises. In a known manner, this drive system comprises at least two pedals 16 and a connecting pin or shaft. By a ring 17, FIG. 2 diagrammatically shows the circular movement of a pedal 16 during the pedaling cycle for showing the end points of displacement of this pedal 16.

This drive system is advantageously mobile relative to a seat 11 placed in the upper part of one of the wall extensions 6 and making possible the seating of the user in such a way as to be able to take into account the morphology of the latter and/or of the type of athletic activity accomplished by the user.

For this purpose, the drive system is mounted on the cassette 9 that can move in translation along an axis of displacement. This cassette 9 is driven in displacement along this axis by a drive system that comprises a vertical endless screw 12 actuated by the user by means of a crank 13 making it possible to control the endless screw 12.

The opening 10 of the cassette body has a horizontal main axis relative to the surface of the bottom of the bath body 2, this opening passing right through the cassette body.

In an advantageous manner, it thus is possible to replace the drive system with another pedal system that is mounted on this opening 10 of the cassette body 9 for performing another physical activity in an aquatic environment. This other pedal system is, for example, a pedal system infinitely reproducing the movement made when steps are climbed, the latter also being known under the name of “stepper.”

The basin body 2 also comprises a crossbar 14 that makes it possible for the user to be held and/or to be supported when carrying out his physical efforts.

Swiveling nozzles placed on the side walls and the opposite walls 3, 4 of the bath body 2 ensure the massaging of certain areas of the lower part of the body of the user during.

This bath is particularly designed to make it possible to perform rehabilitative physical activities in an aquatic environment in a comfortable position.

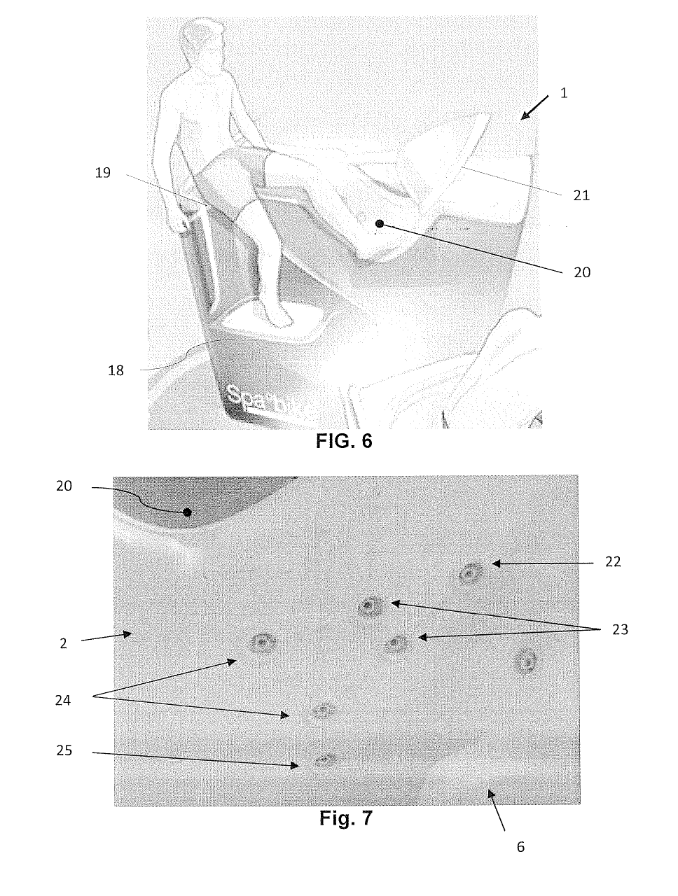

FIG. 6 is a view showing a user that enters the bath body by its open upper end after having climbed several steps of a set of stairs 18 placed outside and adjacent to the bath body 2, this set of stairs forming an integral part of said bath.

To enter the bath, the user seats himself on a so-called transfer saddle 19 placed at the top of this set of stairs 18 and then puts his legs in a side-saddle position through an opening 20 placed in the upper part of the side wall of the bath body. This opening 20 advantageously facilitates the lateral passage of the legs of the user in such a way that the access to the inside volume delimited by the bath body can be gained by the open upper end of this bath body. Advantageously, this opening 20 placed on the side wall of the basin body can be sealed by a hood 21 mounted on the bath body 2 by pivoting by one of its ends. This hood 21 is preferably shaped in such a way that in the sealing position of this hood in which it is folded back to seal the opening 20, the outside surface of the bath is continuous.

The user then slides into the inside of the basin from the rear to the saddle 11 where he can begin his physical activities after having optionally initiated adjustments of the saddle 11 and/or of the cassette 9 along said axis of displacement.

FIG. 7 is a partial and perspective view of the bath body of FIG. 1 showing the arrangement of the nozzles 22-25 on one of the side walls of the basin body. The other side wall of the basin body is identical to this wall in such a way that the two legs and the hips of the user are massaged simultaneously by water jets emitted by these nozzles.

It clearly appears that five 22-24 of the six nozzles arranged on this side wall define a triangle whose tip comprises a nozzle 22 designed to emit a water jet oriented toward a point placed above the seat 11 and essentially at the hip of said user when the latter is seated inside the bath for performing physical activities.

The two nozzles 23 arranged between the base of the triangle and its tip are oriented to send their respective water jets to two separate points of the inside volume, each corresponding to an end displacement position of the user's knee during the use of the pedal system.

Thus, the same point of the knee is massaged by a water jet during its vertical displacement into the inside volume of the basin between two end positions of the pedaling cycle: a low position and a high position. A continuous massaging of this point of the knee is thus advantageously ensured during physical activities of the user.

The nozzle 25, located in the lower part of the side wall of the bath body and placed below five other nozzles 22-24 defining this triangle, has as its object to send its water jet toward a massage point located between the ankle and the knee of the user.

1. Basin comprising a basin body (2) that delimits an inside volume that can house a device for athletic activities for executing physical exercises in an aquatic environment, with said device for athletic activities comprising a frame (8) that can be housed in a removable manner in said basin body (2), characterized in that
With said basin body (2) comprising at least two opposite walls, at least one of said opposite walls defines a wall extension (6, 7) forming a projection into the inside volume delimited by the basin body (2), with the free end of said wall extension (6, 7) comprising a means of receiving/holding one end (15) of said frame (8),
Said frame (8) comprising a cassette (9) that can move in translation along an axis of displacement and a drive system for moving said cassette (9) along said axis of displacement,
Said cassette (9) comprising a body, said cassette body (9) being provided with at least one hole that laterally passes through said cassette body (9) for accommodating a pedal system making it possible to perform physical exercises.

2. Basin according to claim 1, wherein said opposite walls define two wall extensions forming a projection into the inside volume delimited by the basin body (2) by being placed facing one another, with said wall extensions thus defining a housing for receiving said frame (8), the surfaces facing said extensions each comprising a means of receiving/holding one end of said frame (8).

3. Basin according to claim 1, wherein said means of receiving/holding one end of said frame (8) comprises at least one guide rail portion integral with said end or surface of said wall extension (6, 7).

4. Basin according to claim 1, wherein said drive system for moving said cassette (9) along said axis of displacement comprises a vertical endless screw (12) defining a vertical axis along which said cassette (9) moves and an element (13) for control of said endless screw (12).

5. Basin according to claim 4, wherein said control element (13) of said endless screw (12) comprises a crank.

6. Basin according to claim 1, wherein said pedal system is a drive system or a pedal system reproducing the movement made when an individual climbs steps.

7. Basin according to claim 1, wherein said basin body (2) comprises a seat, with said seat (11) being placed in the upper part of one of said wall extensions.

8. Basin according to claim 1, wherein with the unit formed by said frame (8) and said at least one wall extension (6, 7) defining a longitudinal axis and said basin body (2) comprising a seat (11), said seat (11) moves in translation along an axis that is parallel to or merged with said longitudinal axis to allow the seat to be adjusted relative to said frame (8).

9. Basin according to claim 1, wherein said basin body (2) is equipped with an opening in its upper part facilitating the lateral passage of the user's legs in such a way that access to the inside volume delimited by the basin body (2) can be gained via the open upper end of said basin body (2).

10. Basin according to claim 1, wherein said basin body (2) comprises a handle (14) making it possible for the user to support himself.

11. Basin according to claim 10, wherein said handle that comprises at least one grip is connected to said basin body (2) while being movable around an axis of rotation for allowing the adjustment of the position of said at least one grip relative to said frame (8).

12. Basin according to claim 1, wherein said opposite walls of said basin body (2) are connected to one another by side walls between which said frame (8) is placed; at least one of said side walls comprises nozzles that are each designed to emit a water jet.

13. Basin according to claim 12, wherein two of said nozzles are positioned in such a way that the water jets emitted by these two nozzles are sent to two separate points of said inside volume, each corresponding to an end displacement position of the user's knee during the use of said pedal system.

14. Basin according to claim 12, wherein with said basin body (2) comprising a seat (11), one of said nozzles is positioned on one of said side walls in such a way that the water jet emitted by this nozzle is sent to a point placed above said seat (11), approximately at the level of the hip of said user.

15. Basin according to claim 12, wherein the positioning of at least some of said nozzles on said side wall defines a triangle.

16. Basin according to claim 1, wherein said frame (8) comprises a bar forming said axis of displacement, with said bar passing through an opening placed at a first end of said cassette (9).

17. Basin according to claim 16, wherein the other end of said cassette (9) comprises two wings forming extensions of the side walls of said cassette (9) and designed to come on either side of one end of said frame (8) to hold said cassette (9) in position during the actuation of said pedal system by the user.

18. Bath comprising a water basin according to claim 1.

19. Spa comprising a water basin according to claim 1.

20. Method for treatment of the human body for purely aesthetic purposes in which at least the legs and the pelvis of the individual are immersed in a liquid received in a basin according to claim 1, and water jets are sent to at least the legs and the pelvis of said individual at the massage points of the human body.

21. Method of treatment according to claim 20, wherein the position of at least said cassette is adjusted in advance along said axis of displacement in such a way as to adjust the position of the user relative to said jets emitted by said nozzles in such a way that said massage points are touched by said water jets.
